(19) United States
(12) Patent Application Publication
(10) Pub. No.: US 2008/0108041 A1
(43) Pub. Date: May 8, 2008

(54) Toddler product display

(76) Inventors: Jason Ross Dial, Eden Prairie, MN (US); Patrick Michael Kraus, Mason, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/584,064

(22) Filed: Oct. 20, 2006

(51) Int. Cl. G09B 25/00

(52) U.S. Cl. 434/365

(57) ABSTRACT

A product display comprising a toddler locale indicium and toddler product categories are an effective means of marketing to parents with toddlers.

### FIELD OF INVENTION

The present invention relates to a system for merchandizing toddler products in a retail store.

### BACKGROUND OF THE INVENTION

Development of babies and young children is complex and multi-faceted. As a child matures from infancy to young childhood and beyond, he or she will experience physical, physiological, emotional, and other areas of development.

Manufacturers of products designed for babies and young children have long recognized the need to tailor their products to specific stages of child development. For example, diapers for infants are much smaller than for young children. Nipples for bottles have a slower flow rate for newborns as compared to those for infants. There are many such examples.

However, given the myriad of ever increasing products available for babies and small children, it is proving a more difficult retail shopping experience for consumers. This is particularly problematic in larger retail stores (e.g., superstores). The superstores have grown so large that it is often difficult for a shopper to find a product that they are looking for. Making matters worse, the emergence of the large superstore has had a great effect on customer service since the ratio of store clerks to consumers has largely diminished. As a result, consumers are forced to search endless aisles for products meeting their particular needs. What's more, products manufactured for a particular type of consumer are seldom displayed together in the same location and often times not even in the same aisle requiring consumers to embark on an expedition throughout the entire store or simply forgo purchasing the item given the necessary time investment to find the item thereby causing the retailer a lost sale opportunity.

Some solutions have been proposed such as displaying baby care articles according to stages of baby development. There is ideally less confusion and time needed to review the display of the products and selection of the desired item, see US 2006/0173734. However, these displays fall short of addressing the holistic needs of a baby or child by focusing on only a few product categories, typically focusing on products limited to hygiene and feeding (e.g., diapers, wipes, bibs, feeding implements, bath care items, and personal hygiene products).

Another solution is directed to a specialized merchandizing system targeting infants, toddlers, and children under five whereby the system has centers within the system. These centers may include inter alia a nutrition center, equipment center, hygiene center, and clothing center; see US 2006/0173734 A1. Although the diversity of available products for the system is wide, the system fails to address the specific needs associated with toddlers.

Toddlers are particularly unique stage in development, in part, characterized by their learning phase and mental development, e.g., learning words and symbols, starting to talk and communicate, attempting to achieve independence, developing a personality, and overall undergoing a transition from baby to child. Parents want to foster this mental development by exposing toddlers to books, music, DVDs and other forms of visual entertainment /education, games, toys, and other like products to stimulate the intellect of their toddlers. Thus there is also need to provide a convenient shopping experience for parents wanting to purchase products for a toddler's intellect and other products for the toddlers.

Given a toddler's ever growing mental acuity, toddlers are perceptive to the world around them. Toddlers themselves may provide a unique opportunity for a retailer to engage the toddler in a meaningful way (thereby enhancing the shopping experience of the parent or caretaker). Thus, there is an opportunity to market to toddlers themselves.

In view of the foregoing, therefore, there is a need for an in-store merchandizing display or system that speaks to the holistic and unique needs of toddlers yet provide a convenient a pleasant shopping experience for the shopper, particularly in large retail stores.

See also U.S. Pat. Pub. Nos. 2002/0138367; 2002/0072723; 2004/0030308; 2004/0010240; 2006/0121997; and U.S. Pat. No. 6,648,864.

### SUMMARY OF THE INVENTION

The present invention attempts to address these needs by providing, in a first aspect, a display for merchandizing toddler products in a retail store environment comprising a toddler locale, wherein the toddler locale comprises: (a) a toddler locale indicium; (b) at least two (2) different product toddler categories; wherein each of the at least two different toddler categories are identified by a toddler category indicium; and wherein at least one of the at least two different toddler categories comprises a toddler intellect category.

A second aspect provides a method of merchandizing toddler products using the displays of the present invention, preferably in a retail store, alternatively wherein the retail store is a superstore.

In one embodiment, the display of the present invention provides a holistic solution to the parents of toddlers by providing a collection of thematically-similar products to synergistically suggest care solutions for toddlers.

### BRIEF DESCRIPTION OF THE DRAWING

FIG. 1 is directed to an example of displaying toddler products.

### DETAILED DESCRIPTION OF THE INVENTION

Definitions:

“Toddler” is defined as a human from the age of about 6 months to about 48 months, alternatively from about 6 months to about 42 months, or from about 6 months to about 36 months, or from about 6 months to about 18 months, or from about 7 months to about 17 months, or from 8 to 16, 9 to 15, 10 to 14, or 11 to 13, 7 to 11, or 10 months to 17 months, or combinations thereof. A toddler is also typically characterized by a marked learning phase of development, wherein the toddler is inter alia learning to communicate (e.g., recognizing words, symbols and making verbal sounds). A pre-toddler is a human younger than a toddler. A post-toddler is a human child older than a toddler.

“Toddler product” is used herein in the broadest sense and includes a perishable or non-perishable consumer product that is appropriate for use by, on, for, consumable by, a toddler and that can be typically sold in a retail store. For purposes of clarification, the product may also be appropriate for pre-toddlers and post-toddlers. In one embodiment, the toddler product comprises a toddler product indicium.

“Toddler locale” means a multiplicity of toddler products that are localized in reasonable physical proximity to each other, including but not limited to, a kiosk, an aisle or two aisles that face one another, a single aisle and an end-cap, a palletizable display (e.g., US 2005/0067321 A1), or the like; such that the shopper may conveniently obtain different toddler products without traveling to a remote or different region of the store. The toddler locale may be permanent, semi-permanent, temporary, or semi-temporary. In one embodiment, the toddler locale comprises at least one, two, three, four, or more toddler categories.

“Toddler locale indicium” means a graphic that identifies a toddler locale. In one embodiment, the graphic in the toddler locale indicium comprises the term “toddler.” Non-limiting examples of a graphic include those graphics that comprise a word or words chosen from: BECOMING ME; TODDLER STYLE; Toddler Aisle; TODDLERS INSIDE+OUT; or Toddlers. Yet another example of a graphic includes a graphic that comprises an image of a toddler. The image may be a silhouette, an outline, or picture, and the like. The image of the toddler may be one where the toddler is performing an activity such as playing or sleeping, and the like. Without wishing to be bound by theory, the toddler will relate to the image of the toddler and become attracted to the toddler locale.

The indicium may further comprise a “fixture” or “display means,” for example as described in US 2003/0041496 A1, paragraphs 23-26 and paragraphs 27 et seq. The toddler locale indicium may be a primary, secondary, or tertiary toddler locale indicium.

A primary locale indicium is localized at the toddler locale. In one embodiment, the primary toddler locale indicium is in the form of a banner above the toddler locale such that shopper can identify the locale from a remote area of the store. The banner may be suspended from the ceiling of the retail store, preferably localized in the toddler locale, more preferably above the shelves shelving the toddler products. The surface area of a primary locale indicium, in one embodiment, is from about 50 ft² to about 300 ft², alternatively from about 15 ft² to about 200 ft², alternatively from about 10 ft² to about 100 ft². In another embodiment, the width and length dimensions of the primary locale indicium are from about 3-5 feet by 16-24 feet.

A secondary toddler locale indicium is spatially separated from the toddler locale, preferably indicating to shopper where in the retail store the toddler locale is localized. The secondary toddler locale indicium may comprise a televised announcement (e.g., closed circuit television) on a television localized in the retail store or a sign posted at the entrance of the retail storing announcing to the shopper the location of the toddler locale.

A tertiary toddler locale indicium is a graphic generally located outside the retail store indicating to a potential shopper the presence of the toddler locale, alternatively indicating the location of the toddler locale in the retail store. Examples of a tertiary toddler locale indicia may include a print media advertisement, or a commercial on network television, or the like.

“Toddler category” means a multiplicity of toddler products that are organized by a common theme. A physical demarcation such as a partition or a variation in the shelving height, a toddler category indicium, or combinations thereof, may delineate one category from another category. Examples of themes may include eating products, products for playing, resting products, potty products, or learning products, furniture, clothing, a toddler's activities throughout the day, phraseology such as “LIVE,” “LEARN,” and “LAVISH,” and the like. For purposes of clarification, any one particular product may fit within one or more categories. In another embodiment, a toddler category comprises at least two (2) different toddler products, alternatively at least 3, 4, 5, 6, 7, 8, 9, 10, 11, 12, 13, 14, 15, 16, 17, 18, 19, or 20, or more different toddler products. For purposes of clarification, a specific toddler category may comprise products from more than one product category, provided the products are organized by a common theme.

“Toddler intellect category” is a toddler category wherein the toddler products are thematically organized to those products directed to developing a toddler's intellect or mental acuity. Examples of such toddler products may include books, (e.g., reading books, coloring books, interactive books, pop-up books,), videos (movies, television shows), audio (e.g., music, language lessons), games (e.g., board, card, computer, video) and toys. In one embodiment, the toddler product is an educational product. Examples of toys include educational toys such as those from LeapFrog Enterprises, Inc., sold under the trademark LEAPFROG, such as LEARN & GROVE™ counting maracas (“Each shake introduces baby to counting 1-10 in both English and Spanish!”); LEARN & GROVE™ alphabet drum (“Engaging music and interactive play modes encourage baby to tap, crawl and dance, which help develop gross motor skills”); and the like. More educational toys may be found at www.leapfrog.com. Videos are available from The Baby Einstein Company, LLC, under the trademark BABY EINSTEIN™. Various titles are listed at www.babyeinstein.com. In one embodiment, the video and audio in the toddler intellect category may be sampled or is playing (see e.g., US 2003/0163399 A1; US 2004/0117272 A1). In one embodiment, not all products in the toddler intellect category need to share the same theme provided at least two products, alternatively three, or four, toddler intellect categories need not contain all products of the same theme.

“Toddler category indicium” means a graphic identifying a toddler category, preferably localized in the toddler category. In one embodiment, the toddler category indicium is smaller in physical size than a toddler locale indicium. In another embodiment, a primary toddler category indicium is provided and is localized at the top of the shelving of the toddler category. The indicium may comprise a “fixture” or “display means” as described in US 2003/0041496 A1, paragraphs 23 et seq. In one embodiment, the toddler category indicium comprises a surface area from about 5 ft² to about 50 ft², alternatively from about 10 ft² to about 40 ft², alternatively from 15 ft² to 30 ft².

In yet another embodiment, a secondary toddler category indicium is provided. A secondary toddler category indicium is one that reinforces the identification of the toddler category and is localized in the category, typically smaller in physical size than the primary indicium. The secondary indicium may be localized in one, two, or three different locations within the category. For example, the secondary indicium may be localized between the shelving within the toddler category.

“Toddler product indicium” means a graphic identifying a product as a product suitable for toddlers. In one embodiment, the toddler product indicium comprises a sticker affixed to the packaging associated with the toddler product. See e.g., US 2006/0173734 A1(entitled “Display apparatus for and method of displaying baby care articles”).

“Graphic” refers to an image, design, pattern, symbology, trademark, servicemark, or the like. The graphic may comprise a variety of colors and shapes and sizes. Without limitation, the graphic may be printed on cardboard, paper, or plastic. The graphic may be displayed in print media (e.g., newspaper or magazine) or on a television program or commercial (network or closed circuit).

“Spatially separated” refers to regions in a retail store that are not in proximity to one another, such as might require a consumer to travel to a remote or different region of the store, or to exit one region such as an aisle, to reach the item.

### System for Merchandizing

The present invention is directed, in part, to a system for merchandizing toddler products for use within a retail store. The system provides a scheme within the retail store environment of offering a multiplicity of products meeting most, if not all, of the needs of the parents or caregivers of toddlers in one convenient locale. The system, without wishing to be bound by theory, addresses the needs of parents or caregivers of addressing of not only generally the physical needs of the toddler (e.g., nutrition, equipment, hygiene, and clothing) but more importantly the growing intellectual needs of a toddler by providing a toddler intellect category. Another aspect of the present invention recognizes a way for marketers to speak to toddlers themselves by way of providing inter alia the location and/or content of indicia so as to directly speak to the toddlers themselves. Yet another aspect of the invention provides a toddler toy that may assist in the physical development of the toddler (e.g., large plastic bat ergonomically designed for the hands of a toddler and an accompanying large plastic ball). Yet still another aspect may include a “potty” or “toilet trainer” since a toddler using the potty may be considered a development milestone for toddlers.

One aspect of the invention provides a toddler locale further comprising a partitioning element. A “partitioning element” are those fixtures, colors, lights and the like that signal to the shopper that the toddler locale is a distinct area of the store. Non-limiting examples of a partitioning element include colors, lighting, curtains, drapes, dropped ceiling, canopies, flooring—that is unique or distinct, either alone or in combination with other partitioning elements, that signal to the shopper that the toddler locale is a distinct shopping area of the store.

Another aspect of the invention provides a toddler locale that further comprises toddler entertainment. The term “toddler entertainment” is any means of engaging or interacting with a child. Examples of such entertainment may include a television that is playing DVD's appropriate for viewing by toddlers or toys that are available for playing by the toddlers. Packaged versions of the toys may be available for sale. Toddler entertainment may also include food stuffs appropriate for toddlers and that can be consumed by the toddler at or near the toddler locale (such as a CHEERIOS® or fruit juice dispenser). The food stuffs may be free of charge or available for a nominal fee (e.g., 25 cents). Toddler entertainment may comprise a “toddler play area” which comprises a designated area for toddlers to play with toys or crayons to color on coloring books and the like. Preferably the toys and the like at the toddler play area are the same as those that are for sale at the toddle locale. Toddler entertainment may comprise a toddler product removed from its packaging as to allow the toddler to physically engage or interact with the product. Toddler entertainment preferably provides the benefit of keeping toddlers entertained while the shopping parent or caregiver of the toddler is free to browse the toddler locale for toddler products.

In another embodiment, the display (e.g., shelving the toddler products in each toddler category) may comprise a foot print area of the store from about 20 ft² to about 4,000 ft², alternatively from about 100 ft² to about 2,000 ft², alternatively from about 200 ft² to about 1,000 ft². In another embodiment, shelves shelving the toddler products in each category may independently comprise a surface area facing the shopper, measured as a perpendicular plane from the floor of the store to the center of the highest elevated shelf, of from about from about 20 ft² to about 4,000 ft², alternatively from about 100 ft² to about 2,000 ft², alternatively from about 200 ft² to about 1,000 ft². In yet another embodiment, the ratio of any given two toddler categories of a toddler locale, with respect to either: foot print area; or surface area facing the shopper, is about 1:1, alternatively about 2:1, alternatively about 1:2, alternatively about 1:3, alternatively about 3:1, alternatively combinations thereof.

For purposes of clarification, the term “shelves” is used herein the broadest sense to any surface or plurality of surfaces oriented to support toddler products. The surface can be any surface found in a retail environment that is suitable for displaying toddler products. Non-limiting examples of surfaces include shelves, gondolas, countertops, floors, walls, ceilings, pegboards and combinations thereof. The surface may be oriented in a number of ways to support merchandise. For example, in one embodiment, the merchandise may hang via a support that is hooked to a surface, such as a pegboard.

There are many examples of toddler categories (and corresponding toddler category indicia). One example of a toddler category is a “potty” category. A potty category is one characterized by toddler products that are used for learning how to use a toilet. Examples of such toddler products include toilet trainers (e.g., a toilet appropriately sized for toddlers, or a toilet seat adapter to allow toddlers to sit on a full-sized toilet), pre-moistened wipes for wiping the buttocks of a child (e.g., KANDOO™ wipes), hand soap, hygiene products, training diapers (e.g., EASY UPS ), diapers (e.g., including sizes that are typical of toddlers that include 3 (16-28 lb (7-13 kg)), 4 (22-37 lb (10-17 kg)), 5 (27 lb+(12 kg+)), 6 (35+lb (16 kg+)), or combinations thereof), a step stool (to assist a toddler in obtaining access to a full size toilet), and the like, or combinations thereof.

Another example of a toddler category is “playing.” The playing category may include toys and games, jackets, hats, gloves, laundry detergent (e.g., TIDE® liquid or powder detergent), and the like, or combinations thereof.

Another example of a toddler category is “eating.” The eating category may include toddler products such as food storage containers, snacks, drinks, sippy cups, utensils (toddler size, i.e., ergonomically designed and angled for a toddler), frozen toddler meals, cereal, and the like, or combinations thereof.

Another example of a category is “swimming.” Examples of toddler products in a lavish category may include bathing suits, floatation devices, sunscreen, hats (to shield the toddler's head or face from the sun), and toys suitable to use in a pool.

Another example of a toddler category is “periodic.” Period categories are those that are changed in a periodic basis and may include: “back to school” (toddler products may include: school supplies such as crayons, shoes, drawing paper, or combinations thereof); “valentine's day” (products may include candy), “Christmas” (products may include Santa, stuffed animals of reindeer, and elves), “Easter” (products may include plastic eggs, egg coloring kits, and baskets capable of holding eggs); “Fourth of July” (products may include a USA flag) ; “gardening” (products include gardening shovel); camping (products may include sleeping bag, tent, mosquito repellent for toddlers), and the like, or combinations thereof. In one embodiment, “periodic” means the toddler category in the toddler locale is changed on a weekly, monthly, or quarterly basis.

There are many examples of a toddler intellect category. One example of a toddler category indicium for the toddler intellect category is an indicium that comprises the word “Resting.” The resting category may include toddler products such books, DVDs, educational toys, educational books, educational games, educational DVDs, fabric softener (liquid fabric softener such as DOWNY or a dryer sheet such as BOUNCE), sleep wear (e.g., pajamas), and the like, or combinations thereof.

Another example of a toddler category indicium for the toddler intellect category is an indicium that comprises the word “Learn.” Examples of toddler products in a learn category may include those sold under the trademark of LEAP FROG, as well as DVDs and books.

There are many examples of toddler category indicia. An example of a primary toddler category indicium of the toddler category of “potty” is a graphic that comprises the word(s) “potty” or “potty time.” An example of a second toddler category indicium of the toddler category of “potty” is a graphic that comprises the words “using the potty makes me a big kid.” For the toddler category of “resting,” the primary indicium may be a graphic that comprises the word(s) “quiet” or “quiet time.” The secondary indicium for the category of “resting” may include a graphic that comprises the words “night, night, don't let the bed bugs bite!” For the category of “playing” the primary indicium may be a graphic that comprises the word(s) “play” or “play time.” The secondary indicium for the category of “playing” may include a graphic that comprises the words “play time is my funniest time.” For the category of “eating” the indicium may be a graphic that comprises the word(s) “eat,” “munch,” “snack,” or “munch time.”

Examples of toddler categories and category indicia may include “live” and “lavish.” Examples of toddler products that may categorized under the “live” category may include clothes, shoes, boots, jackets, jewelry, hats, etc. and the like. In another embodiment, the live category may comprise toddler products directed to camping or gardening. “Lavish” may also include clothes, or “high end” clothing alternatively clothing for special occasions.

One aspect of the invention may include the placement of indicia to capture the attention of the toddler. In one embodiment, any one or more of the indicium (e.g., primary, secondary, tertiary category indicium) is located about or near the eye level of a standing toddler (e.g., from about 1 ft to about 5 ft, alternatively from about 2 ft to about 4 ft, alternatively from about 2 ft to about 3 ft). In another embodiment, any one or more of the indicium is located about or near the eye level of a toddler sitting in a grocery cart (e.g., from about 3 ft to about 6 ft, alternatively 4 ft to about 5 ft as measured from the floor to the middle of the indicium). In yet another embodiment, any of one or more of the indicium at about or near the eye level of the toddler comprises a graphic of a toddler. Without wishing to be bound by theory, but indicium and eye level of the toddler will more likely engage the toddler. This engagement, again without wishing to be bound more by theory, may be more effective to the toddler if it includes a graphic of a toddler or a toddler performing an activity.

### EXAMPLE

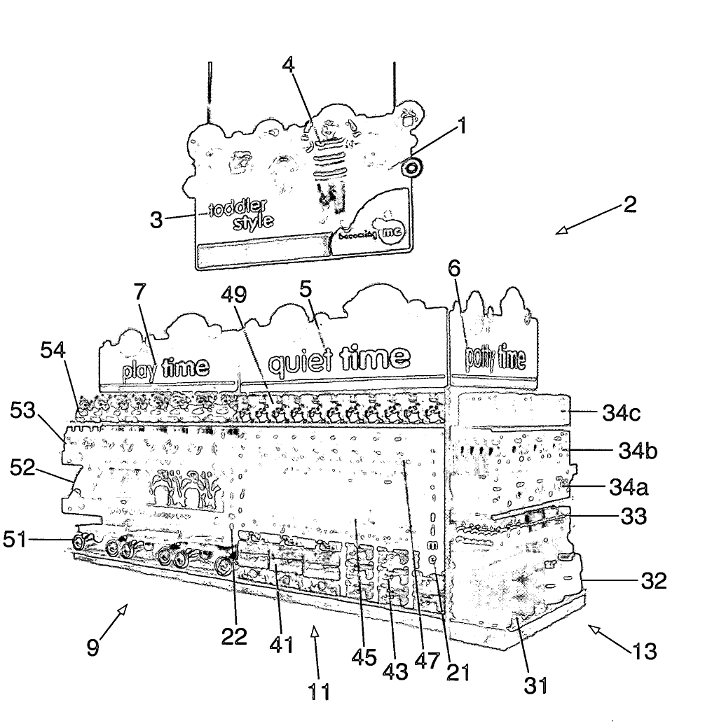

In one embodiment of a display for merchandizing toddler products in a retail store environment 2 is provided in FIG. 1. A toddler locale indicium 1 indicates the location of the display to a shopper in the retail store. The graphic of the toddler locale indicium 1 may comprise the words “toddler style” 3 and a picture of a toddler standing 4. The display 2 is organized into three toddler categories, specifically a potty category 13, and a resting category (i.e., a “toddler intellect category”) 11, and playing category 9. The graphic of the toddler category indicia that describes these categories comprises the words “potty time” 6, “quiet time” 5, and “play time” 7, respectively. Two of the respective categories each also comprise a secondary toddler category indicium 21, 22 comprising the same words as the primary indicium “quiet time” 21 and “play time” 22 wherein the indicium protrudes out from the shelving. There is a multiplicity of toddler products available at the display 2. For example in the potty category 13 the products available include a step stool 31, a training potty 32, and diapers of various sizes 34a, 34b, 34c. In the resting category 11, there are DVDs of movies and education programming 41, reading books 43, sleepwear 45, liquid fabric softener 47, and dryer sheets 49. In the play time category 9, there are a wagons 51, coats 52, liquid laundry detergent 53, and stuffed animals 54.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A display for merchandising toddler products in a retail store environment comprising a toddler locale, wherein the toddler locale comprises:
(a) a toddler locale indicium;
(b) at least two (2) different toddler categories; wherein each of the at least two different toddler categories are identified by a toddler category indicium;
and wherein at least one of the at least two different toddler categories comprises a toddler intellect category.

2. The display of claim 1, wherein the toddler intellect category comprises at least one product chosen from a book, video, audio, game, toy, or combination thereof

3. The display of claim 2, wherein the toddler intellect category comprises at least two products chosen from a book, video, audio, game, toy, or combination thereof.

4. The display of claim 3, wherein the toddler intellect category comprises at least three products chosen from a book, video, audio, game, toy, or combination thereof.

5. The display of claim 1, wherein the toddler intellect category comprises at least a book or video.

6. The display of claim 2, wherein the at least one product is labeled as “educational.”

7. The display of claim 6, wherein the display comprises a diaper and a toddler toy.

8. The display of claim 2, further comprises at least three (3) different toddler categories, wherein each of the at least three different toddler categories are identified by a toddler category indicium.

9. The display of claim 2, wherein the toddler locale indicium comprises a graphic, wherein the graphic comprises the word “toddler.”

10. The display of claim 8, wherein the graphic of the toddler locale indicium comprises comprise an image of a toddler.

11. The display of claim 9, further comprising a secondary toddler locale indicium comprising
a graphic, wherein the graphic comprises the word “toddler”;
and wherein the display further comprises a potty or toiler trainer.

12. The display of claim 2, wherein the footprint area of the display comprises from about 50 ft² to about 1,000 ft².

13. The display of claim 11, wherein the surface area of the toddler locale indicium comprises from about 5 ft² to about 50 ft².

14. The display of claim 11, wherein the toddler intellect category comprises at least two products chosen from a book, video, audio, game, toy, or combination thereof.

15. The display of claim 9, wherein the display comprises a diaper.

16. The display of claim 12, wherein the display comprises a diaper.

17. The display of claim 16, wherein at least one toddler product within the toddler intellect category is labeled as “educational.”

18. The display of claim 17, wherein the toddler locale indicium comprises a graphic, wherein the graphic comprises the word “toddler.”

19. The display of claim 18, wherein the graphic of the toddler locale indicium comprises comprise an image of a toddler.

20. A method of merchandizing toddler products in a retail store environment comprising the steps of displaying a toddler locale according to claim 1 in a retail store.
